(19) United States
(12) Patent Application Publication
(10) Pub. No.: US 2004/0250456 A1
(43) Pub. Date: Dec. 16, 2004

(54) Slimline display signage lighting

(76) Inventor: Brian Hart Welker, Pfafftown, NC (US)

Correspondence Address: ROBERT W PITTS, PO BOX 11483, WINSTON-SALEM, NC, 27116-1483, US

(21) Appl. No.: 10/461,519

(22) Filed: Jun. 13, 2003

(51) Int. Cl. G09F 13/00

(52) U.S. Cl. 40/541

(57) ABSTRACT

A merchandising rack or cabinet, or display rack or case 2 includes a plurality of shelves 6 on which merchandise can be stored as part of a point of sale display. One or more hinged doors 20 are mounted on the front of the merchandising rack 2 in front of at least one of the shelves 6. A light source 70 is located adjacent a bottom edge of the door 20 to provide interior illumination and to backlight a graphic or sign mounted on the front of the door 20. A reflector 76 disperses the light from the offset source more evenly across the front surface 26 of the door 20. The door is suspended from viscous damping hinges 80, which retard rotation of the door when moved between open and closed positions. A slimline combination door, lighting apparatus and signage display can thus be employed without appreciably changing the size of the merchandising display 2.

### BACKGROUND OF THE INVENTION

1. Field of the Invention

This invention relates to merchandising racks or cabinets or point of sale display racks that are used to both display and dispense consumer goods, including but not limited to cosmetics, tobacco products, film, and CD's. More specifically, this invention relates to lighted racks or displays in which the goods being displayed are illuminated and in which illumination is provided for graphics, signs or other advertisements which may be included on the front of the rack, cabinet or display.

2. Description of the Prior Art

Merchandising or display racks are commonly employed in retail establishments, such as grocery stores, drug stores, speciality stores and department stores. Individual racks or display cabinets are commonly employed to both store and display similar consumer goods. A single rack or cabinet can be used to display a number of brands for a single manufacturer. Similar competing products offered by different vendors can also be housed in the same display rack. Quite often different brands, either competing or complementary, are displayed on different shelves of the same merchandising rack or cabinet. An example of one such dispensing or merchandising rack is disclosed in U.S. Pat. No. 6,193,085. The items located on the interior of this dispensing rack are illuminated by fluorescent lighting fixtures located in a header at the top of the merchandising rack. This fluorescent lighting fixture also illuminates a translucent graphic or other signage located on the front of the header. This configuration, and others like it, limit the illuminated signage to the top of the dispensing rack. Each rack will typically contain a number of individual shelves or trays, each containing different items or different brands. With this type of dispensing rack, separate illuminated signage or graphics cannot be supplied for items on individual shelves or trays. Furthermore, the light is located at the top of the dispensing rack, and illumination at the bottom of the dispensing rack will therefore be compromised. Alternative configurations employ multiple light sources in different locations within the dispensing rack or merchandising display. For example, fluorescent light fixtures can be substituted for individual shelves or trays. This approach, however, reduces the storage capacity, because light fixtures must be substituted for storage shelves or trays.

No known prior art device provides for illumination of both the interior of a merchandising rack and as a backlight for a graphic or other sign that can be positioned in front of individual shelves or trays of a merchandising rack, while at the same time not occupying potential storage space or appreciably enlarging the size of the merchandising display. This invention addresses these limitations as well as others, such as helping to prevent damage to or theft of merchandise stored on the dispensing rack as well as helping to prevent injury to customers or employees using the merchandising rack.

### SUMMARY OF THE INVENTION

An apparatus according to this invention can be used to exhibit a sign on a merchandising rack. This apparatus includes a door with upper and lower tracks for supporting the sign. A light is disposed adjacent at least one of the tracks, the lower track in the preferred embodiment, and the light is positioned to illuminate the sign from behind. A reflector extends beyond the light to disperse illumination from the light. Hinges are located adjacent the upper track so that the apparatus can be rotated between a closed position covering items stored in the display rack and an open position permitting access to items stored in the merchandising rack.

This apparatus thus comprises a signage display for use on a merchandising rack. The signage display comprises a door mountable on a front face of the merchandising rack. The door can also include a track on which a sign can be mounted on a front surface of the door. One or more hinges are located at a top edge of the door and suspend the door from the merchandising rack. The hinge dampens rotation of the door as the door moves from an upper open position to a lower closed position. An electric component, such as fluorescent lamp, can be located behind the front surface of the door, and the lamp can illuminate the sign from behind as well as illuminating the interior of the merchandising rack when the door or sign holder is open.

This assembly also comprises a lighting assembly for lighting a merchandising display. The light source, which can be a fluorescent lamp or other lighting fixture, is mounted within an enclosure. The enclosure is at least partially open to transmit light on front, rear and bottom surfaces to illuminate the interior of the merchandising display and to provide frontal illumination or to backlight a sign or graphic located on the front of the enclosure. Hinges are mounted adjacent a top surface of the enclosure and are attached to the merchandising display to suspend the lighting assembly along a front face of the merchandising display. The enclosure is rotatable about the hinges for access to a portion of the merchandising display behind the enclosure.

Multiple door or enclosure subassemblies can be part of a point of sale merchandising rack, which also includes a plurality of shelves on which merchandise can be stored. The doors or enclosures comprise a plurality of signage displays mounted on a front surface of the merchandising rack. Each signage display is movable from a closed position to an open position for access to merchandise stored on at least one shelf. At least one light is mounted on at least one signage display and offset from a horizontal centerline of that signage display to illuminate a sign from behind. A reflector for distributing illumination from the light more evenly relative to the sign is also included. The light can be offset from the horizontal centerline to reduce the thickness of the signage display when a reflector of this type is employed.

### BRIEF DESCRIPTION OF THE DRAWINGS

FIG. 1 is a representative three dimensional view of a point of sale merchandising display rack in which a single flip up door with an integral lighting fixture is located on the front of the display rack.

FIG. 2 is an enlarged view of the merchandising display rack of FIG. 1, showing a flip up door with integral lighting fixture as well as adjacent trays or shelves.

FIG. 3 is an exploded three-dimensional view of most of the components of flip up door shown in FIGS. 1 and 2.

FIG. 4 is three-dimensional view of a display door or cover, absent the fluorescent light that could be mounted in this display door.

FIG. 5 is a view of the front of the assembled door shown in FIG. 4, and also showing mounting hardware that is used to mount the door on the merchandising display rack.

FIG. 6 is a three dimensional view of the upper track used in the door of FIGS. 4 and 5.

FIG. 7 is an end view of the track shown in FIG. 6.

FIG. 8 is a three-dimensional view of the downlight window located along the bottom edge of the door.

FIG. 9 is a three-dimensional view of the hinge housing.

FIG. 10 is a three-dimensional view of the hinge pin received in the hinge pin housing of FIG. 9.

FIG. 11 is a view of the hinge arm that can be attached to the hinge pin.

FIG. 12 is a view of a preferred embodiment of a hinge mounting bracket. The relative size of the hinge arm and the hinge mounting bracket is best seen in FIG. 5.

FIG. 13 is a view of the body, which forms the rear of the door and to which other components are mounted to form the illuminating door.

FIG. 14 is a view of an alternate embodiment of an illuminating door in which fluorescent lamps can be mounted along the top and bottom edges of the door.

### DETAILED DESCRIPTION OF THE PREFERRED EMBODIMENTS

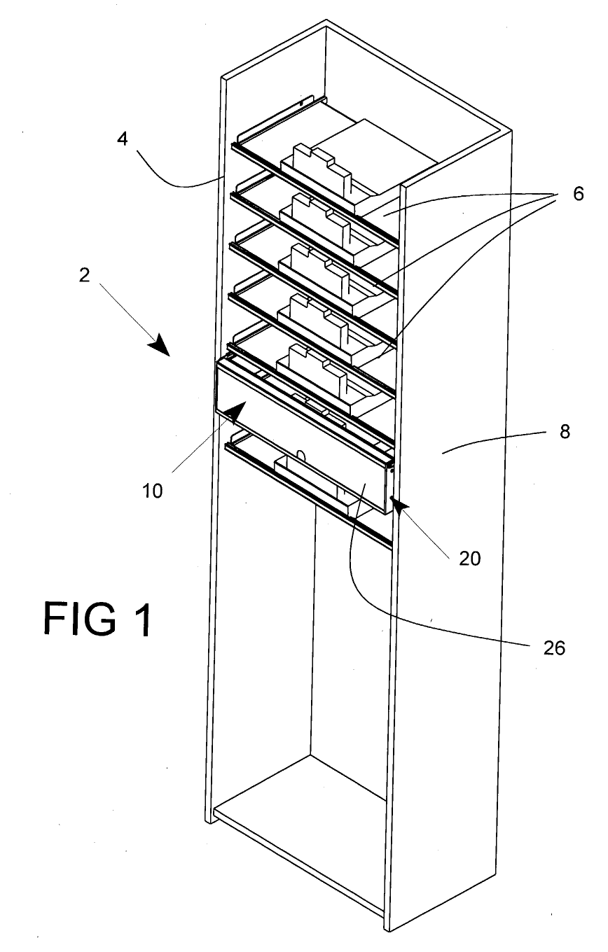

The representative merchandising display rack or cabinet 2, shown in FIG. 1, can be used as a point of sale display rack in a commercial or retail establishment where it is important to present items in a convenient and effective manner. Rack 2 contains a plurality of shelves or trays 6 on which merchandise can be both stored and displayed. Each shelf 6 extends between opposite cabinet walls 8, and the individual shelves 6 can be mounted in any number of conventional ways. The front surface 4 of the rack 2 can be open or it can be partially or completely closed by illuminated signage displays 10 in the form of doors 20 that flip up to expose a shelf or shelves located behind the illuminated signage display. 10. A graphic or advertisement can be mounted in the signage display 10 and illuminated from behind. The illuminated signage display 10 will also provide illumination for the interior of the display rack 2 in a manner that will become more apparent as the components of the door 20 forming the illuminated signage display 10 are discussed in more detail.

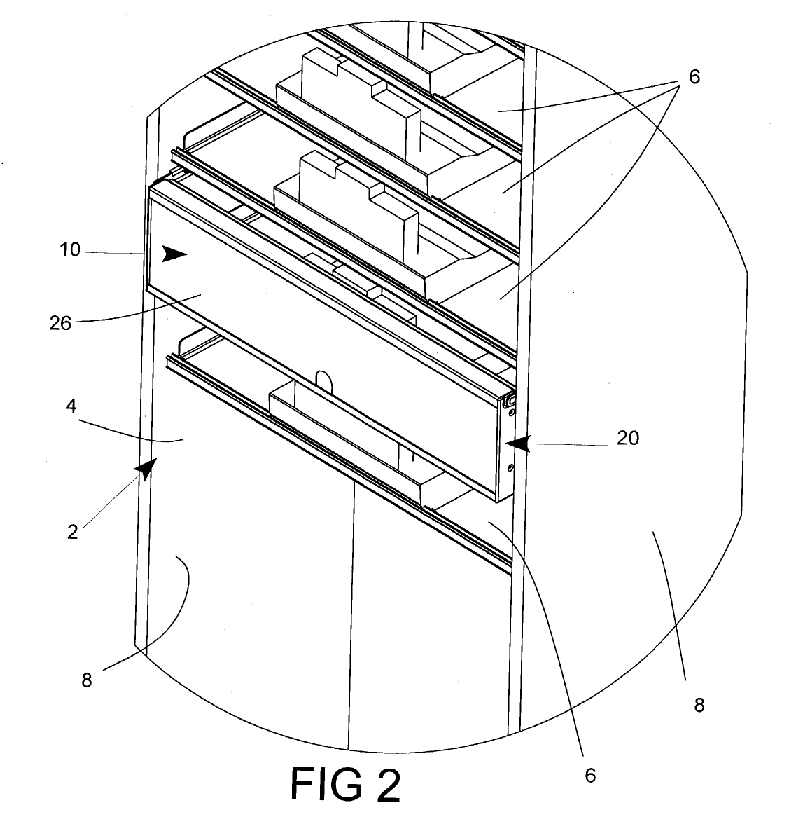

Illuminated doors or sign holders 20 can be mounted on the display rack 2 to cover each shelf 6 or some of the shelves 6 can remain exposed. Only a single signage display 10 formed by one door 20 is shown in FIG. 1 and the enlarged view of FIG. 2. These views are intended to demonstrate the relative positions of the major components forming the display cabinet or rack 20, and normally more than one door 20 would be used in a typical installation.

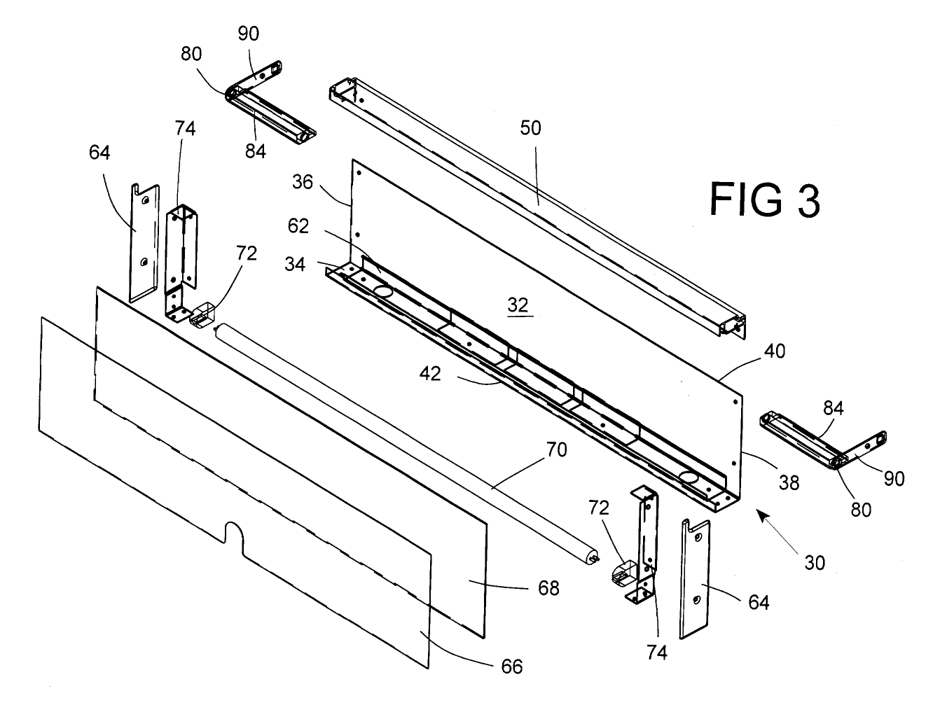

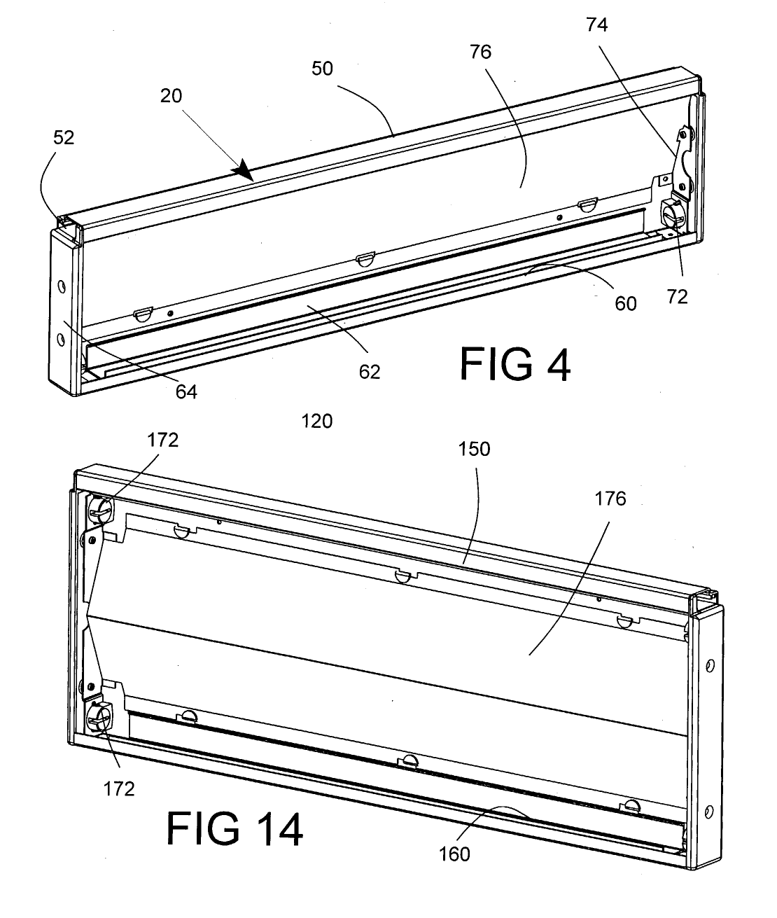

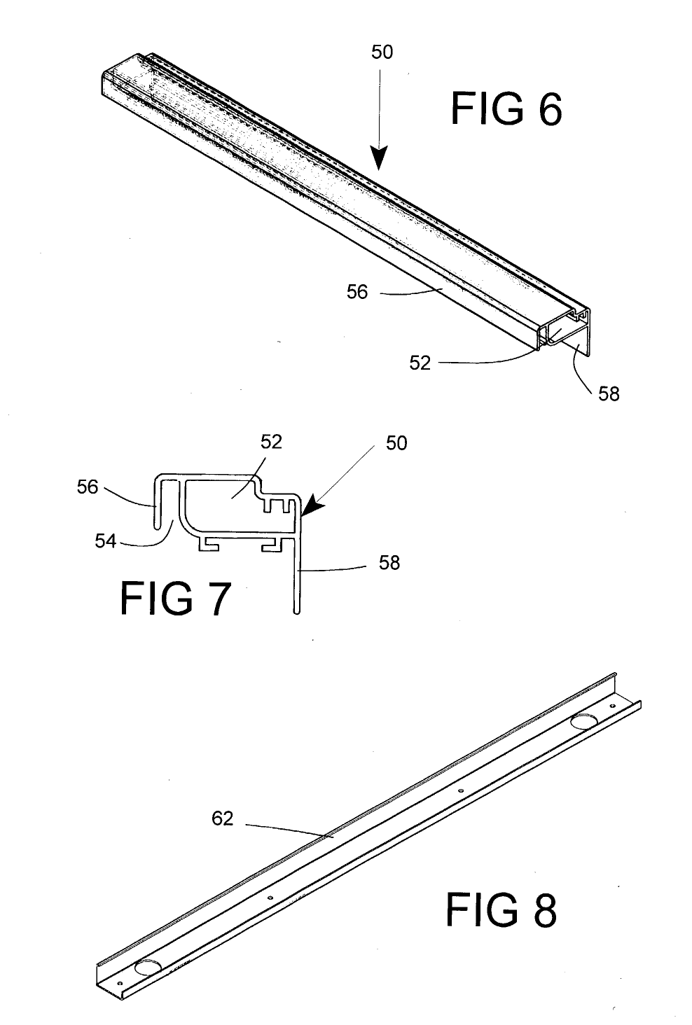

Most of the components needed to construct a first embodiment of an illuminated door 20 are shown in FIG. 3 and an assembled door 20 is shown in FIG. 4. The door 20 includes a body 30, which includes a rear panel 32 to which an upper track 50 and a downlight window 62 can be attached. The rear panel 32 is also shown in FIG. 13. The upper track 50 is also shown in FIGS. 6 and 7. The downlight window 62 is also shown in FIG. 8. A lower track 60 is formed between the downlight window 62 and the bottom of the rear panel 32.

The first embodiment of the illuminating door assembly 20 also includes a single fluorescent lamp or tube 70 that is located adjacent the bottom edge of the door 20. The fluorescent lamp 20 is mounted in two fluorescent lamp sockets 72 located adjacent opposite edges of the door. The fluorescent lamp sockets 72 are mounted on brackets 74, which are attached to the rear panel 32. End caps 64 can then be mounted to the brackets 74.

A clear cover 66 and diffuser 68, together with a graphic or sign, not shown, can be mounted on the front surface 26, seen in FIGS. 1 and 2, of the illuminating door 20. The cover 66 and diffuser 68, as well as the graphic or sign, will generally be either transparent or translucent and will be backlit by the fluorescent lamp 70.

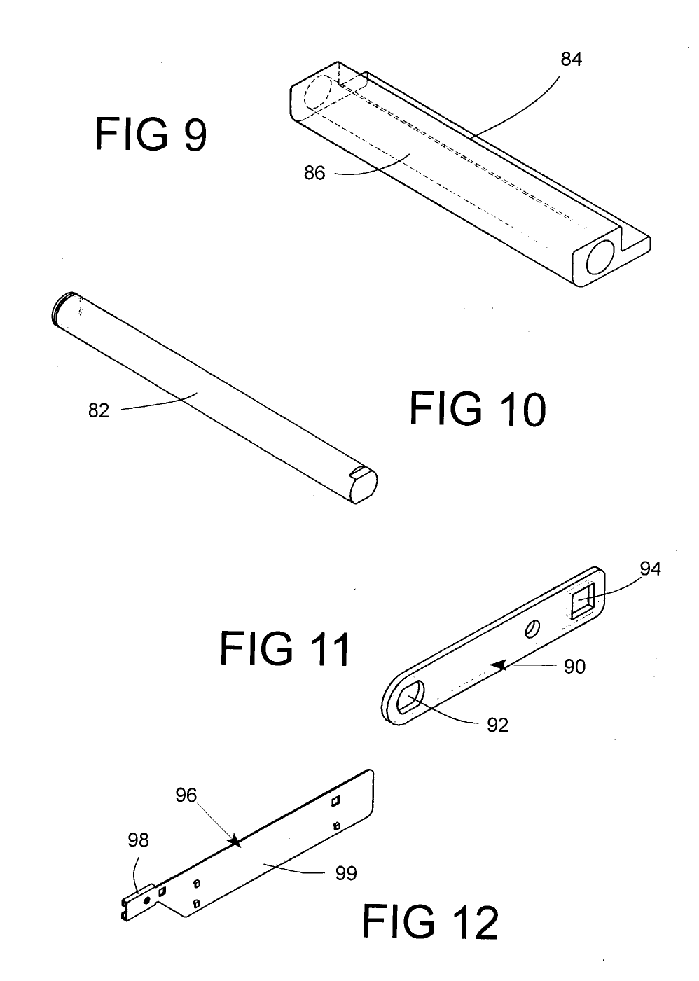

The door 20 is hinged relative to the display rack 2 so that the door can be flipped upward for access to merchandise located on a shelf behind the door. Two hinges 80 are located on opposite edges of the door 20. In this embodiment, each hinge 80 can be inserted into the open ends 52 of the upper track 50, which are shown in greater detail in FIGS. 6 and 7. Each hinge 80 includes a hinge pin 82, mounted in a hinge housing 84, and a hinge arm 90 can be attached to the hinge pin 82. The hinge arm can be attached to the display rack walls 8 by hinge mounting brackets 96. Hinges 80 and hinge assemblies are shown in greater detail in FIGS. 9-12. The door 20 can be rotated about the hinges 80 to an open position and can subsequently be allowed to rotate under the force of gravity to the close position shown in FIGS. 1 and 2. As will be subsequently discussed in greater detail, the hinges 80 comprise damping means or viscous damping means so the doors will fall into the closed position at a rate that will not cause damage to either the door 20, the door components, to the display rack 2 or to the merchandise stored behind the door 20. The reduction in velocity will also help prevent inadvertent injury to a person inserting or retrieving an item from the rack, especially a customer who may not be familiar with the operation of the devices. Although the representative embodiments depicted herein employ viscously damped hinges on both ends of the doors or sign holders 20, some applications may require a damping hinge on only one end, in which case an idler hinge, with no viscous damping means, can be employed on the opposite end.

The main door component that is not shown in FIG. 3 is the light reflector 76 that extends at an angle upwardly form the lamp 70 located at the lower edge of the door 20. This reflector 76 is however shown in FIG. 4. Together with the diffuser 8, the reflector 76 will disseminate the light emitted by the fluorescent lamp 70 more evenly on the door front surface 26 so that an graphic or advertising material will be more evenly lighted. To disseminate the light, the reflector 76 is angled and the top edge of the reflector 76 will be closer to the front of the door 20, than its lower edge, which will extend behind the lamp 70 and the downlight window 62. By positioning the light source 70 at the bottom of the door 20, with the reflector 76 extending upwardly therefrom, the depth of the door 20 can be reduced resulting in a relatively slim lighting assembly. The overall depth of the merchandising rack 2 is therefore not appreciably increased.

The upper track 50 serves both the secure the top edge of the graphic, sign or advertisement on the front of the door 20 and to connect the two hinges 80 at opposite upper corners. Upper track 80 has a constant cross section between its opposite ends, and it can be extruded from a material, such as aluminum, although other metallic or nonmetallic materials could be used. In the preferred embodiment, all sections of the upper track have a constant wall thickness of 0.060 in., although this is not necessary. The openings 52 at either end are merely opposite ends of a constant somewhat oblong or rectangular closed wall channel extending along the entire length of the upper track. The shape of these openings 52 correspond to the outer shape of the hinge housing 84, which will be inserted into openings 52 so that the hinge housing 84 cannot rotate relative to the upper track 80 or to the door 20 on which the track is mounted. A front lip 56 forms the front of a downwardly facing groove 54, into which the top edge of the cover 66, the diffuser 68 and the selected graphic are inserted. A rear mounting lip 58 extends along the rear track face below the portion of the track defining the channel and openings 52. As can be seen from FIG. 3, the upper track 50 can be mounted along the top body edge 40 by attaching the rear mounting lip 58 to the rear panel 32. The openings 52 will then extend beyond the rear panel 32 adjacent both the first end 36 and the second end 38 of the rear panel 32, so that the hinge housings 84, and therefore the hinges 80 can be inserted into the track openings 52, and the hinges 80 can be mounted on the body 30. Since the cross section of the openings 52 remains constant, the extent to which the hinge housings 84 are inserted into the track openings 52 can vary, and the lateral position of the hinges 80 can be adjusted so that the same door 20 can be mounted on multiple versions racks or cabinets 2 that need not have the same width or spacing of the walls 10.

The lower edge of the graphic, sign or advertisement as well as the cover 66 and the diffuser 68 are held in place by a lower track formed between the lower edge 42 of the panel 32 and the front portion of the downlight window 62. The downlight window 62 and the rear panel lower flange 34 also provide a means for illuminating the interior of the merchandising rack when the door 20 is in the closed position. As shown in FIG. 13, the rear panel 32 includes openings 33 extending into the both the lower flange 34 and the back of the rear panel. The downlight window 62, shown in detail in FIG. 8, fits within the interior of the J-shaped body panel 32 as shown in FIG. 3. Downlight window is formed of a clear plastic material, such as and 0.050 inch thick vinyl. Light from the tubular fluorescent lamp 70 can then shine downwardly and rearwardly through the openings 33 and the downlight window 62 to illuminate the interior of the merchandising rack 2.

A lighted or illuminating door assembly 20 according to this invention will illuminate both the interior of the merchandising rack 2 and will provide backlighting for a graphic or sign mounted on the front surface of the door 20. However, the fluorescent light 70, or other light source located in the door assembly 20 must not be damaged when the door 20 is opened and closed. This is especially the case when the light 70 is located at the bottom of the door 20, which flips up or rotates about an axis along the top of the door. The hinges 80 employed in this invention are viscous damped hinges, which generate a force that will retard or slow down rotation of the door 20, at least relevant to the rotational velocity that could be achieved without this viscous damping. This type of hinge can also be referred to as a torque engine. As shown in FIGS. 9-12, the hinge assembly includes four primary components in addition to a viscous material or grease that is not shown. Preferably, a highly viscous grease should be used, although different viscosities can be used for specific applications. The hinge housing 84 has a housing bore 86 that extends through at least most of the length of the hinge housing. This housing bore 86 has an internal diameter that is large enough to receive a hinge pin 82 and the viscous grease or damping material that will act to retard rotation of the hinge pin 82 relative to the hinge housing 84. The hinge pin 82 can be secured within the hinge housing 84 by attachment of a split ring, not shown, in a groove on one end of the hinge pin 82. The outer diameter of the hinge pin 82 shown in FIG. 10 is substantially constant between opposite ends. This means that the gap between the hinge pin 82 and the inwardly facing surface of the housing bore 86 is substantially constant along the entire length of the hinge pin 82. The viscous damping force will thus be evenly distributed over substantially the entire length of the hinge pin 82 in the housing bore 86. For some applications this damping force could be excessive for the mass of the door or sign holder 20, resulting in an undesirably slow rotation of the door 20 from an upper or flip up position to a closed position. In such applications a hinge pin in which a portion of the pin has been machined to have a smaller outer diameter can be substituted. The separation between the hinge pin and the interior surface of the housing bore will be significantly greater over that portion of the assembly resulting is less damping or retardation. The damping force can therefore be adjusted by only modifying one component of the hinge assembly, and the same hinge housing 84 can be used for multiple applications. This scalability is important because it permits the same basic hinge assembly to be used with door or sign holders 20 having different sizes with only a single relatively minor modification. Thus the same basic hinge assembly can be used for doors 20 having different lengths or heights for use with different shelf assemblies or with a wide variety of products or merchandise having significantly different sizes. A slightly modified version of this basic hinge assembly can also be employed in a configuration in which the viscous retarding force is less and therefore rotational velocity of the door or sign holder 20 is greater as the door is opened than when it is closed. Therefore, the door could be more easily opened, but the same amount of damping could be achieved as the door closes. Asymmetrical rotation of the hinge assembly of this type can be achieved by employing an eccentrically shaped hinge pin in a cylindrical bore or an cylindrical hinge pin in an eccentrically shaped bore. The damping in one rotational direction would thus be significantly greater than the damping in the opposite rotational direction.

The hinge assembly 80 also includes a hinge arm 90, which is attached to one end of the hinge pin 82. Hinge arm 90 includes an oblong opening 92, which in the preferred embodiment has two opposed flat sides with curved ends. This oblong hinge arm opening 92 is shaped to receive one end of hinge pin 82, which has two oppositely and outwardly facing machined flat sections. The hinge arm 90 can be secured to the hinge pin in any number of conventional ways, including by adhesives, crimping, welding, soldering, upsetting or other means depending upon the material from which the pin 82 and the hinge arm 90 are formed and upon manufacturing and economic considerations. In any event the hinge arm 90 is firmly attached to the hinge pin 82.

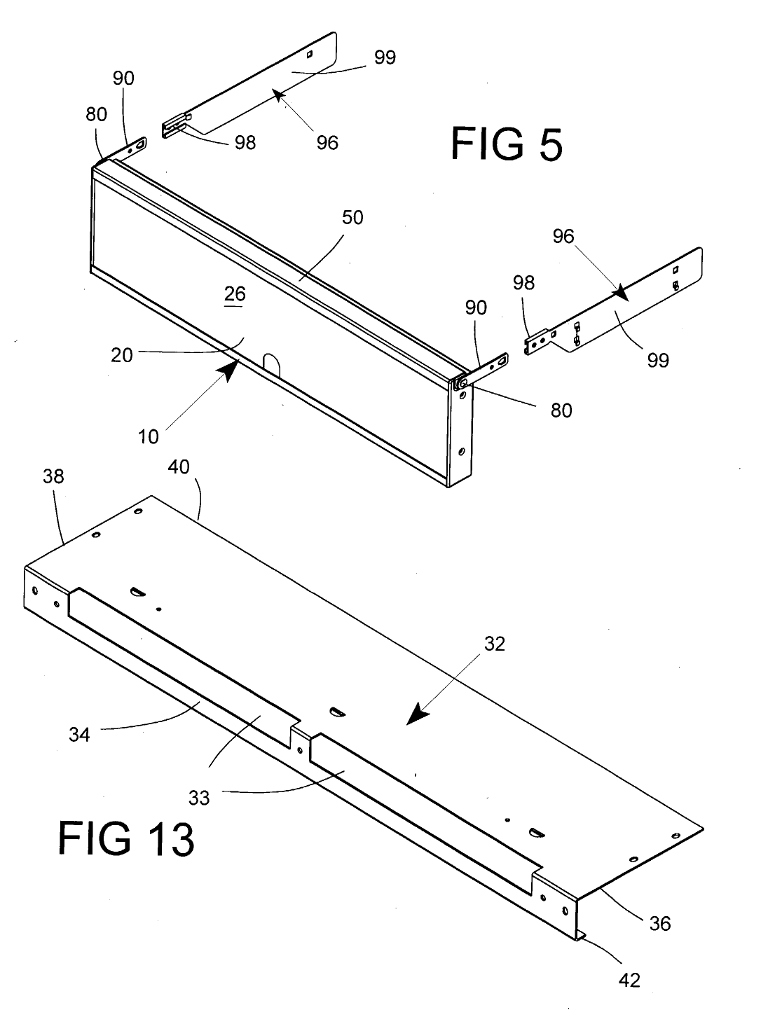

The opposite end of the hinge arm 90 can be attached to a hinge bracket 96, as shown in FIG. 5, by pushing the hinge arm 90 into a groove formed by folding over edges of the hinge bracket to form a bracket connection 98. In this preferred embodiment, the bracket connector 98 can include an embossment that will snap into a hole 94 located adjacent a leading end of the hinge arm 90 to hold the hinge arm 90 in the hinge connector 98. Sufficient force applied to the hinge arm 90 can snap the hinge arm 90 into the hinge connection 98, and an extraction force can be applied to remove the hinge arm 90, and therefore the hinge assembly from the hinge bracket 96. Openings in the hinge arm 92 and the hinge bracket 96 can be aligned for insertion of a securing member, such as a fastener or screw, that must be removed to disconnect these two members.

The hinge bracket 96 includes a hinge blade 99 that includes conventional fastener means to allow hinge brackets 96 to be attached to opposite inner walls 8 of the merchandising cabinet or rack 2. In a normal installation, the hinge brackets 96 will first be mounted on opposed cabinet walls 8 above a shelf or shelves 6 that the door 20 is intended to cover. Two hinges 80 will have been positioned with the hinge housings 84 extending into the end openings 52 in the upper track 50. As previously discussed, the openings 52 are configured to receive the hinge housings 84 in one orientation, and the hinge housings 84 will not be free to rotate relative to the upper track 50 and to the door 20 on which the upper track 50 is mounted. The hinge housings 84 are however free to shift longitudinally in the track end openings 52 relative to the upper track 50 so that the relative spacing of two hinges 80 at opposite ends can be adjusted. This adjustment permits alignment of the hinge arms 90 with hinge brackets 96 that have been previously attached to the cabinet walls 8. Adjustment in this manner can also allow the same door 20 to be used with racks or cabinets 2 having differing widths.

With the hinge arms 90 attached to both the cabinet walls 8 and the hinge pins 82, and with the hinge housings 84 attached to the door 20, through the track 50, relative rotation will occur between the hinge pins 82 and the hinge housings 84 as the door 20 is rotated relative to the rack 2. The viscous material in the hinge housing bore 84 surrounding the hinge pin 82 will retard the rotational velocity of the door 20 relative to the rack 2 and will prevent damage to the light 70 and to other components of the door 20.

The first embodiment of the door 20 has a height sufficient to cover one standard shelf 6 on a standard cabinet 2. One light 70 on this door 20 will illuminate a graphic or sign so that the door will serve as a signage display for merchandise stored on that corresponding shelf 6. As previously discussed the single light source 70 will also illuminate the merchandise on the shelf 6 in both the closed and open positions. FIG. 14 shows another embodiment of this invention in which the height of the door 120 is greater than the height of one of the shelves 6 shown in FIGS. 1 and 2. This door 120 also includes two sets of light sockets 172 so that two lights, one adjacent the top edge and upper track 150, while the other light is adjacent the lower edge and lower track 160. The reflector 176 used in this embodiment is also angled inwardly from both lights to more evenly disperse light on the front face of the door 120. Reflector 176 comprises two angled surfaces, each of which converge toward the center of the door 120 and form a single mirrored surface with a bend line located at the midlevel of the reflector 176. Openings can be provided on the rear panels (not shown) of the door assembly 120 to provide illumination to the interior of the rack. A downlight window identical to the downlight window 62 used in the embodiment of FIG. 3 can be provided along the lower edge of the door 120. The same hinges 80 can be used in the embodiment of FIG. 14, and they can be mounted and will function in the same manner. The door 120 can then serve as a signage display for multiple shelves, which could all contain higher volume merchandise stored on multiple shelves. Alternatively, door 120 can serve to cover shelf space having a greater height than that shown in FIGS. 1 and 2, which may be suited for use with merchandise having a greater size.

The two embodiments of doors that provide slimline frontal lighting for a merchandising rack are merely representative of other embodiments that can employ different components, or have a different size, or can be intended for use with a merchandising rack having a different construction. Additional features can also be included. For example, some embodiments could include a spring in addition to the viscous damping hinge to insure that the doors will completely close. A latch can also be included to lock the door in a closed position. Different hinge housings, in which the hinge mounting bore is located either fore or aft of the location shown in the representative embodiment, can be used to adjust the door pitch and the rest position of the door. Windows can also be added to the upper track for additional interior illumination. Light emitting diodes can be used instead of the tubular fluorescent lights used in the preferred embodiment. This invention is also suitable for use with visual displays that are more elaborate than a simple lighted sign or graphic. For example, this invention is especially suitable for use with a sign having other electrical components. For example, the sign could include a visual readout, such as a pricing display employing LCD's or LED's that could be remotely programmed. Kinetic displays driven by an electric motor could also be employed. These examples demonstrate that the invention is not limited to the representative configuration and components shown herein, but is instead defined by the following claims.

What is claimed is:

1. An apparatus for exhibiting a sign on a merchandising rack comprising:
a door including upper and lower tracks for supporting the sign;
a light disposed adjacent at least one of the tracks, the light being positioned to illuminate the sign from behind the sign;
a reflector extending beyond the light to disperse illumination from the light; and
hinge means located adjacent the upper track so that the apparatus can be rotated between a closed position covering items stored in the display rack and an open position permitting access to items stored in the merchandising rack.

2. The apparatus of claim 1 wherein the hinge means comprises separate hinges located at opposite ends of the door.

3. The apparatus of claim 2 wherein the hinges comprise viscous damping hinges for slowing rotation of the apparatus from the open to the closed position.

4. The apparatus of claim 1 wherein the light comprises a tube light extending between opposite ends of the door.

5. The apparatus of claim 1 wherein the door includes a rear panel with the lower track extending forward from a bottom edge of the rear panel.

6. The apparatus of claim 1 wherein the door includes a rear panel and the upper track is attachable along a top edge of rear panel.

7. The apparatus of claim 6 wherein the upper track includes open ends in which individual hinges, comprising the hinge means, can be inserted.

8. The apparatus of claim 7 wherein the open ends in the upper track are located behind a groove in which the sign can be inserted.

9. The apparatus of claim 8 wherein the upper track is formed from an extruded member having a constant cross section between opposite open ends.

10. The apparatus of claim 1 wherein the light and the reflector are mounted on a rear panel.

11. The apparatus of claim 1 wherein the hinge means comprises separate hinges, each hinge comprising a hinge housing having a bore extending therein and a pin extending into the bore, each hinge also including a viscous material disposed in the bore for damping rotation of the pin relative to the housing.

12. The apparatus of claim 11 wherein the hinge housing of each hinge is insertable into individual openings located adjacent opposite ends of the door, each hinge housing being received within a corresponding opening to prevent rotation of the hinge housing relative to the door.

13. The apparatus of claim 11 wherein each hinge includes a rearwardly extending arm matable to a mounting bracket securable to the merchandising rack to mount the apparatus to the merchandising rack.

14. The apparatus of claim 13 wherein the hinge housings are insertable into openings in the upper track and are laterally shiftable relative to the upper track so the apparatus can be mounted on merchandising racks having differing widths.

15. The apparatus of claim 1 wherein the apparatus comprises a flip up door rotatable about a horizontal axis.

16. A retail signage display comprising:
a flip up sign holder for displaying a sign, rotation of the flip up sign holder from a flip up position to a closed position being restricted by a damping hinge;
a bracket attachable to and detachable from a merchandise cabinet for mounting the sign holder in front of the merchandise cabinet so that, when in the closed position, the flip up sign holder displays the sign in front of at least a portion the merchandise cabinet but does not protrude into storage space within the merchandise cabinet; and
a light in the sign holder positioned to backlight the sign and to illuminate interior spaces in the merchandise cabinet.

17. A signage display for use on a merchandising rack, the signage display comprising a door mountable on a front face of the merchandising rack, the door further comprising:
a track for mounting a display component on a front surface of the door;
a hinge located at a top edge of the door and suspending the door from the merchandising rack, the hinge damping rotation of the door as the door moves from an upper open position to a lower closed position; and
an electrical component for enhancing the display component, spaced from the track and the hinge.

18. The signage display of claim 17 wherein the electrical component comprises a light located behind the front surface of the door to illuminate the display component from behind.

19. The signage display of claim 17 wherein separate hinges are attached to opposite ends of one track, which includes means for supporting a top edge of the display component when mounted on the door.

20. The signage display of claim 17 wherein the hinge is mounted on the track.

21. A point of sale merchandising rack comprising:
a plurality of shelves comprising means on which merchandise can be stored;
a plurality of signage displays mounted on a front surface of the merchandising rack, each signage display being movable from a closed position to an open position for access to merchandise stored on at least one shelf;
at least one light mounted on at least one signage display and offset from a horizontal centerline of the at least one signage display to illuminate a sign mounted in the at least one signage display from behind; and
a reflector for distributing illumination from the light more evenly relative to the sign so that the light can be offset from the horizontal centerline to reduce the thickness of the signage display.

22. A lighting assembly for lighting a merchandising display, the lighting assembly comprising:
a light source;
an enclosure in which the light source is mounted, the enclosure being at least partially open to transmit light on front, rear and bottom surfaces of the enclosure to illuminate the interior of the merchandising display and to provide frontal illumination; and
hinge means mounted adjacent a top surface of the enclosure, the hinge means being attachable to the merchandising display to suspend the lighting assembly along a front face of the merchandising display, the enclosure being rotatable about the hinge means for access to a portion of the merchandising display behind the enclosure.
